(19) United States
(12) Patent Application Publication
(10) Pub. No.: US 2025/0084910 A1
(43) Pub. Date: Mar. 13, 2025

(54) LOW-PRESSURE MAGNETORHEOLOGICAL DAMPER

(71) Applicant: BeijingWest Industries Co., Ltd., Beijing (CN)

(72) Inventors: Marcin KNAPCZYK, Krakow (PL); Waldemar WIDLA, Zabierzow Bochenski (PL)

(21) Appl. No.: 18/767,967

(22) Filed: Jul. 9, 2024

(30) Foreign Application Priority Data
Sep. 13, 2023 (CN) 202311181816.4

(51) Int. Cl. F16F 9/53; F16F 9/06; F16F 9/34; F16F 9/516

(52) U.S. Cl. CPC F16F 9/535; F16F 9/062; F16F 9/064; F16F 9/34; F16F 9/516; F16F 2222/06; F16F 2222/12; F16F 2228/066; F16F 2230/18; F16F 2230/42

(57) ABSTRACT

A magnetorheological (MR) damper includes: a main tube defining an MR chamber containing an MR fluid having a viscosity that varies in response to application of a magnetic field. A piston rod is disposed at least partially within the main tube. An MR piston is connected to the piston rod and divides the MR chamber into an MR rebound chamber and an MR compression chamber. The MR piston includes an MR rebound valve that regulates a flow of the MR fluid from the MR rebound chamber into the MR compression chamber during a rebound stroke, thereby generating a rebound damping force. A base valve assembly regulates flow of a standard fluid. The rebound damping force is generated substantially entirely by the MR rebound valve of the MR piston. A compression damping force is generated by an MR compression valve of the MR piston together with the base valve assembly.

### CROSS-REFERENCE TO RELATED APPLICATION

This application claims priority to Chinese Patent Application No. 202311181816.4 filed Sep. 13, 2023, which is incorporated herein by reference in its entirety.

### BACKGROUND OF THE INVENTION

### 1. Field of the Invention

The present invention generally relates to a suspension damper for a vehicle. More specifically, the present invention relates to a suspension damper that includes a magnetorheological (MR) fluid.

### 2. Description of the Prior Art

Damper assemblies are well known in the art for use in a vehicle. One such an MR damper is disclosed in Patent publication U.S. Pat. No. 5,706,920A which discloses a monotube MR damper including a main tube disposed on a center axis and extending between a first end and a second end. The damper defines a fluid compartment between the first end and the second end for containing a working fluid. A main piston is slidably disposed in the fluid compartment dividing the fluid compartment into a rebound compartment and a compression compartment. A piston rod is disposed on the center axis extending along the center axis to a distal end and attached to the main piston for moving the main piston between a compression stroke and a rebound stroke.

Magnetorheological (MR) dampers are increasingly used on vehicles to continuously control damping characteristics for proper ride and handling in all driving situations. Magnetorheological fluid generally consists of a clear carrier or base fluid (e.g. polyalphaolefin) with suspended particles. When the particles are charged with a magnetic field, they line up and change the viscosity of the fluid, which in turn can be used to control damping forces.

### SUMMARY OF THE INVENTION

The present invention provides a magnetorheological (MR) damper. The MR damper comprises a main tube defining an MR chamber containing an MR fluid. The MR fluid has a viscosity that varies in response to application of a magnetic field. The MR damper also comprises: a piston rod disposed at least partially within the main tube; and an MR piston connected to the piston rod and dividing the MR chamber into an MR rebound chamber and an MR compression chamber. The MR piston includes an MR rebound valve configured to regulate a flow of the MR fluid from the MR rebound chamber into the MR compression chamber during a rebound stroke, thereby generating a rebound damping force. The MR damper also comprises a standard fluid chamber containing a standard fluid. The standard fluid has a viscosity that does not vary with application of a magnetic field. The MR damper also comprises a base valve assembly configured to regulate a flow of the standard fluid. The rebound damping force is generated substantially entirely by the MR rebound valve of the MR piston.

The present invention also provides a method for operating a magnetorheological (MR) damper. The method comprises: moving, by a piston rod, an MR piston through an MR chamber containing an MR fluid, the MR fluid having a viscosity that varies in response to application of a magnetic field, the MR piston dividing the MR chamber into an MR rebound chamber and an MR compression chamber; regulating, by a MR rebound valve of the MR piston, a flow of the MR fluid from the MR rebound chamber into the MR compression chamber during a rebound stroke, thereby generating a rebound damping force; and regulating, by a base valve assembly, a flow of a standard fluid having a viscosity that does not vary with application of a magnetic field. The rebound damping force is generated substantially entirely by the MR rebound valve of the MR piston.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a fragmentary view of a vehicle suspension including an MR damper

in accordance with the present invention;

FIG. 2 shows a cross-sectional schematic view of a first MR damper according to

an aspect of the present disclosure;

FIG. 3 shows a cross-sectional schematic view of a second MR damper according to an aspect of the present disclosure; and

FIG. 4 shows a flow chart illustrating steps in a method for operating an MR damper according to an aspect of the present disclosure.

### DESCRIPTION OF THE ENABLING EMBODIMENT

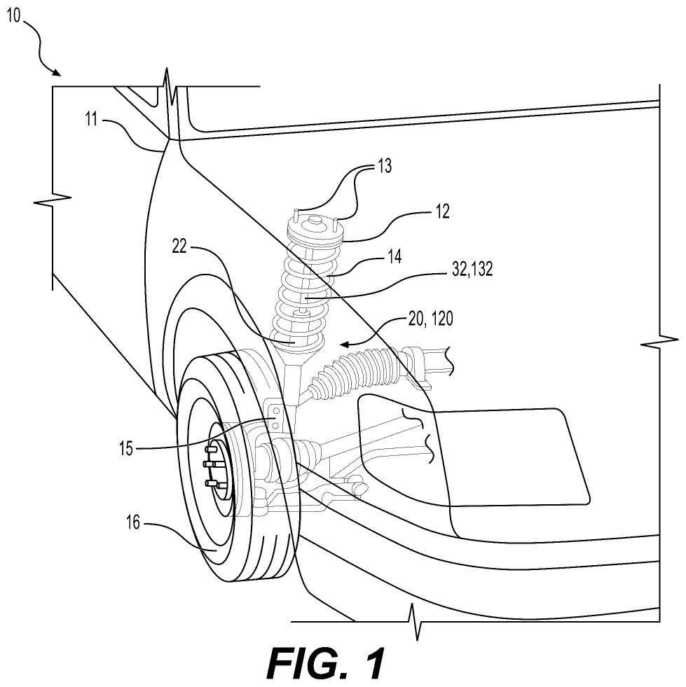

Referring to the Figures, wherein like numerals indicate corresponding parts throughout the several views, it is one aspect of the present invention to provide a magnetorheological (MR) damper 20, 120 for a vehicle 10. A generally illustrated in FIG. 1, the MR damper 20, 120 is attached to a chassis 11 of the vehicle 10 by a top mount 12. A number of screws 13 extend through an upper surface of the top mount 12 to fasten the top mount 12 to a body of the vehicle 10. The top mount 12 is connected to a coil spring 14 and a piston rod 32, 132 of the MR damper 20, 120. The MR damper 20, 120 is also connected to a knuckle 15 supporting a wheel 16 of the vehicle 10.

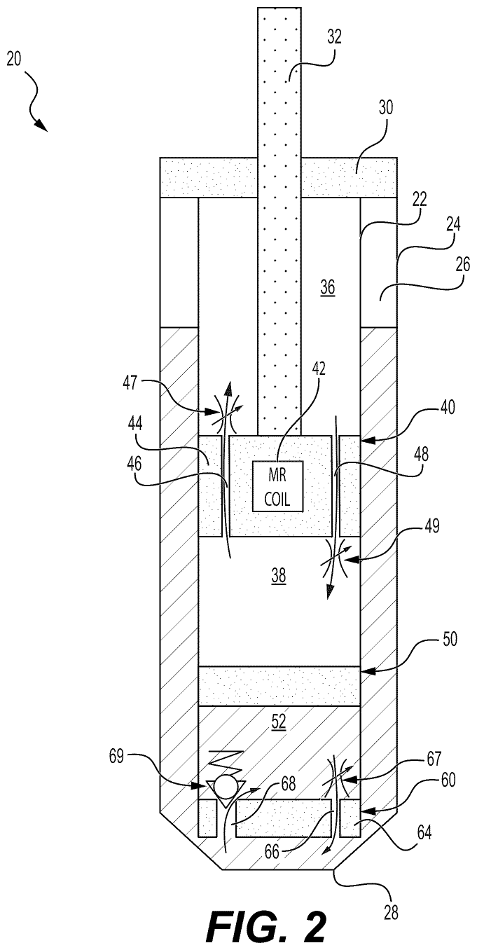

FIG. 2 generally shows a first MR damper 20 which may be used for the MR damper 20, 120 of the vehicle 10. The first MR damper 20 has a twin-tube configuration including an first main tube 22 and an outer tube 24 disposed coaxially around the first main tube 22 and defining a compensation chamber 26 annularly therebetween. The first MR damper 20 includes a closed end 28 and a first rod cap 30 opposite the closed end 28 and enclosing an end of each of the first main tube 22 and the outer tube 24. A first piston rod 32 is disposed at least partially within the first main tube 22. The first piston rod 32 extends through the first rod cap 30 and into the first main tube 22. The first main tube 22 defines a first MR chamber 36, 38 that contains an MR fluid. The MR fluid has a viscosity that varies in response to application of a magnetic field

A first MR piston 40 is disposed in the first main tube 22 and attached to an end of the first piston rod 32. The first MR piston 40 is slidable in an axial direction within the first main tube 22 and seals against an inner surface of the first main tube 22 to divide the first MR chamber 36, 38 into a first MR rebound chamber 36 and a first MR compression chamber 38. The first MR piston 40 includes a first MR coil 42 that is configured to generate a magnetic field for varying the viscosity of the MR fluid, and thereby dynamically adjusting the damping characteristics of the first MR damper 20 in either or both of a compression direction and/or a rebound direction. The first MR coil 42 may be connected to an electrical power source via wires that run through the first piston rod 32 (not shown in the FIGs).

The first MR piston 40 includes a first piston body 44 that defines a first MR compression fluid passage 46 providing a flow path for the MR fluid between the first MR compression chamber 38 and the first MR rebound chamber 36 during a compression stroke. The first MR piston 40 also includes a first MR compression valve 47 configured to regulate a flow of the MR fluid through the first MR compression fluid passage 46, from the first MR compression chamber 38 and into the first MR rebound chamber 36 during the compression stroke. The first MR compression valve 47 may also function as a check valve, blocking fluid from flowing through the first MR compression fluid passage 46 during the rebound stroke. The first MR compression valve 47 may include one or more variable orifices, which may include deflective discs to regulate the fluid flow.

The first piston body 44 of the first MR piston 40 also defines a first MR rebound fluid passage 48 providing a flow path for the MR fluid between the first MR compression chamber 38 and the first MR rebound chamber 36 during a rebound stroke. The first MR piston 40 also includes a first MR rebound valve 49 configured to regulate a flow of the MR fluid through the first MR rebound fluid passage 48, from the first MR rebound chamber 36 into the first MR compression chamber 38 during a rebound stroke. The first MR rebound valve 49 may also function as a check valve, blocking fluid from flowing through the first MR rebound fluid passage 48 during the compression stroke. The first MR rebound valve 49 may include one or more variable orifices, which may include deflective discs to regulate the fluid flow.

The first MR damper 20 also includes a first fluid separator 50 that separates the first MR compression chamber 38 from a first standard fluid chamber 52, which contains a standard (i.e. non-MR) fluid, such as an oil, and which has a viscosity that does not vary with application of a magnetic field. In some embodiments, and as shown in FIG. 2, the first fluid separator 50 may include a floating piston disposed in the first main tube 22 and which is slidable in an axial direction within the first main tube 22. The floating piston of the first fluid separator 50 seals against an inner surface of the first main tube 22 to separate the first MR compression chamber 38 from the first standard fluid chamber 52 and to prevent the MR fluid from contacting the standard fluid.

The first MR damper 20 also includes a first base valve assembly 60 disposed adjacent to the closed end 28 and configured to regulate a flow of the standard fluid between the first standard fluid chamber 52 and the compensation chamber 26, which may contain a combination of the standard fluid and a gas. The Gas may compress during the rebound stroke to take-up volume in the first MR damper 20 occupied by the first piston rod 32, as the first piston rod 32 enters through the first rod cap 30.

The first base valve assembly 60 includes a first valve body 64 that defines a first base compression fluid passage 66 providing a flow path for the standard fluid between the first standard fluid chamber 52 and the compensation chamber 26. The first base valve assembly 60 also includes a first base compression valve 67 configured to regulate flow of the standard fluid through the first base compression fluid passage 66, from the first standard fluid chamber 52 and into the compensation chamber 26 during the compression stroke. The first base compression valve 67 may also function as a check valve, blocking fluid from flowing through the first base compression fluid passage 66 in an opposite direction during the rebound stroke. The first base compression valve 67 may include one or more variable orifices, which may include deflective discs to regulate the fluid flow.

The first valve body 64 of the first base valve assembly 60 also defines a first base rebound fluid passage 68 providing a flow path for the standard fluid between the compensation chamber 26 and the first standard fluid chamber 52. The first base valve assembly 60 also includes a first base check valve 69 configured to allow fluid flow through the first base rebound fluid passage 68, from the compensation chamber 26 and into the first standard fluid chamber 52, while blocking fluid from flowing through the first base compression fluid passage 66 in an opposite direction. The first base check valve 69 is shown schematically on FIG. 2, and it may include various structures, such as a ball and seat and/or one or more deflective discs to provide the one-way flow regulating functionality. The first base check valve 69 may provide relatively little flow restriction in the rebound direction, therefore generating no significant damping force in the rebound direction.

The twintube design of the first MR damper 20 includes a low-pressure gas in the compensation chamber 26 to be used as volume compensation. It includes passive oil mixing with gas in the reservoir tube (no physical separation). Compression forces are generated by both the first MR piston 40 and by the first base valve assembly 60. Rebound forces are generated entirely, or substantially entirely by the first MR piston 40. The first base valve assembly 60, which may be called a passive base valve because it acts upon the standard fluid and not the MR fluid, may be used to define minimum compression forces (secondary ride). The first MR piston 40 may be used for all rebound damping (secondary +primary ride) and compression body damping (primary ride). The first MR piston 40 may have an asymmetrical force profile, generating less force in a compression direction than the rebound damping force in a rebound direction.

The combination of the first MR piston 40 with the first MR compression and rebound valves 47, 49, and the first base valve assembly 60 with the first base check valve 69 and the first base compression valve 67 causes the first MR damper 20 to generate compression forces by both the first MR piston 40 and the first base valve assembly 60, while rebound forces are generated substantially entirely by the first MR piston 40. This provides advantages over alternative damper designs, including better comfort and isolation, lower gas charge, wider tuning range in the compression stroke due to shorter response time and less temperature sensitivity.

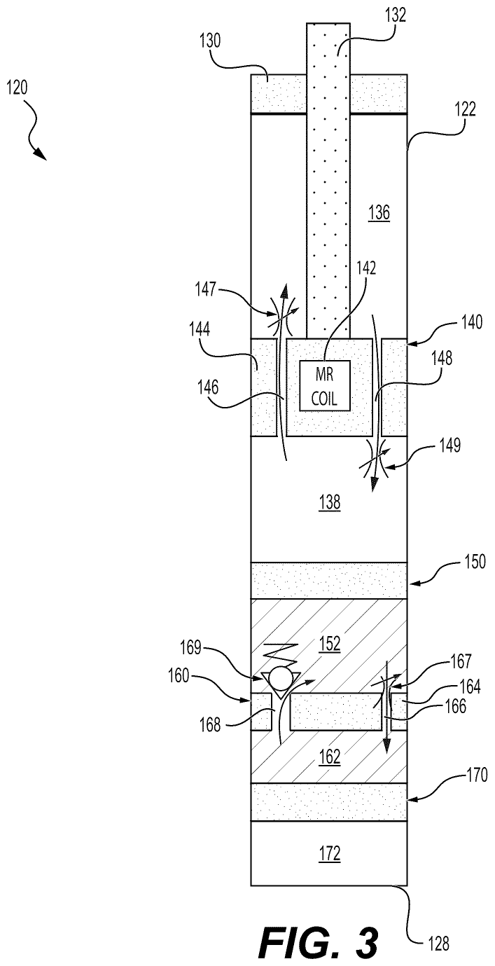

FIG. 3 generally shows a second MR damper 120 which may be used for the MR damper 20, 120 of the vehicle 10. The second MR damper 120 has a monotube configuration including a second main tube 122 with a closed end 128. The second MR damper 120 includes a second rod cap 130 that encloses an end of the second main tube 122 opposite the closed end 128.

A second piston rod 132 extends through the second rod cap 130 and into the second main tube 122. The second main tube 122 defines a second MR chamber 136, 138 that contains an MR fluid. The MR fluid has a viscosity that varies in response to application of a magnetic field.

A second MR piston 140 is disposed in the second main tube 122 and attached to an end of the second piston rod 132. The second MR piston 140 is slidable in an axial direction within the second main tube 122 and seals against an inner surface of the second main tube 122 to divide the second MR chamber 136, 138 into a second MR rebound chamber 136 and a second MR compression chamber 138. The second MR piston 140 includes a second MR coil 142 that is configured to generate a magnetic field for varying the viscosity of the MR fluid, and thereby dynamically adjusting the damping characteristics of the second MR damper 120 in either or both of a compression direction and/or a rebound direction. The second MR coil 142 may be connected to an electrical power source via wires that run through the second piston rod 132 (not shown in the FIGs).

The second MR piston 140 includes a second piston body 144 that defines a second MR compression fluid passage 146 providing a flow path for the MR fluid between the second MR compression chamber 138 and the second MR rebound chamber 136 during a compression stroke. The second MR piston 140 also includes a second MR compression valve 147 configured to regulate a flow of the MR fluid through the second MR compression fluid passage 146, from the second MR compression chamber 138 and into the second MR rebound chamber 136 during the compression stroke. The second MR compression valve 147 may also function as a check valve, blocking fluid from flowing through the second MR compression fluid passage 146 during the rebound stroke. The second MR compression valve 147 may include one or more variable orifices, which may include deflective discs to regulate the fluid flow.

The second piston body 144 of the second MR piston 140 also defines a second MR rebound fluid passage 148 providing a flow path for the MR fluid between the second MR compression chamber 138 and the second MR rebound chamber 136 during a rebound stroke. The second MR piston 140 also includes a second MR rebound valve 149 configured to regulate a flow of the MR fluid through the second MR rebound fluid passage 148, from the second MR rebound chamber 136 into the second MR compression chamber 138 during a rebound stroke. The second MR rebound valve 149 may also function as a check valve, blocking fluid from flowing through the second MR rebound fluid passage 148 during the compression stroke. The second MR rebound valve 149 may include one or more variable orifices, which may include deflective discs to regulate the fluid flow.

The second MR damper 120 also includes a second fluid separator 150 that separates the second MR compression chamber 138 from a second standard fluid chamber 152, 162, which contains a standard (i.e. non-MR) fluid, such as an oil, and which has a viscosity that does not vary with application of a magnetic field. In some embodiments, and as shown in FIG. 3, the second fluid separator 150 may include a floating piston disposed in the second main tube 122 and which is slidable in an axial direction within the second main tube 122. The floating piston of the second fluid separator 150 seals against an inner surface of the second main tube 122 to separate the second MR compression chamber 138 from the second standard fluid chamber 152, 162 and to prevent the MR fluid from contacting the standard fluid.

The second MR damper 120 also includes a second base valve assembly 160 disposed within the second standard fluid chamber 152, 162, dividing the second standard fluid chamber 152, 162 into an upper chamber 152 and a lower chamber 162. The second base valve assembly 160 is configured to regulate a flow of the standard fluid between the upper chamber 152 and the lower chamber 162 of the second standard fluid chamber 152, 162. In some embodiments, and as shown in FIG. 3, the second base valve assembly 160 may include a floating piston disposed in the second main tube 122 and which is slidable in an axial direction within the second main tube 122.

The second base valve assembly 160 includes a second valve body 164 that defines a second base compression fluid passage 166 providing a flow path for the standard fluid between the upper chamber 152 and the lower chamber 162. The second base valve assembly 160 also includes a second base compression valve 167 configured to regulate flow of the standard fluid through the second base compression fluid passage 166, from the upper chamber 152 and into the lower chamber 162 during the compression stroke. The second base compression valve 167 may also function as a check valve, blocking fluid from flowing through the second base compression fluid passage 166 in an opposite direction during the rebound stroke. The second base compression valve 167 may include one or more variable orifices, which may include deflective discs to regulate the fluid flow.

The second valve body 164 of the second base valve assembly 160 also defines a second base rebound fluid passage 168 providing a flow path for the standard fluid between the lower chamber 162 and the upper chamber 152. The second base valve assembly 160 also includes a second base check valve 169 configured to allow fluid flow through the second base rebound fluid passage 168, from the lower chamber 162 and into the upper chamber 152, while blocking fluid from flowing through the second base compression fluid passage 166 in an opposite direction. The second base check valve 169 is shown schematically on FIG. 3, and it may include various structures, such as a ball and seat and/or one or more deflective discs to provide the one-way flow regulating functionality. The second base check valve 169 may provide relatively little flow restriction in the rebound direction, therefore generating no significant damping force in the rebound direction.

The second MR damper 120 also includes a gas cup 170 disposed in the second main tube 122 and separating the lower chamber 162 of the second standard fluid chamber 152, 162 from a gas compartment 172 which contains a gas. The Gas may compress during the rebound stroke to take-up volume in the second MR damper 120 occupied by the second piston rod 132, as the second piston rod 132 enters through the second rod cap 130. In some embodiments, the gas cup 170 may be configured as floating piston that is slidable in an axial direction within the second main tube 122.

The monotube design of the second MR damper 120 includes a low-pressure gas in the gas compartment 172 to be used as volume compensation. Compression forces are generated by both the second MR piston 140 and by the second base valve assembly 160. Rebound forces are generated entirely, or substantially entirely by the second MR piston 140. The second base valve assembly 160, which may be called a passive base valve because it acts upon the standard fluid and not the MR fluid, may be used to define minimum compression forces (secondary ride). The second MR piston 140 may be used for all rebound damping (secondary +primary ride) and compression body damping (primary ride). The second MR piston 140 may have an asymmetrical force profile, generating less force in a compression direction than the rebound damping force in a rebound direction.

The combination of the second MR piston 140 with the second MR compression and rebound valves 147, 149, and the second base valve assembly 160 with the second base check valve 169 and the second base compression valve 167 causes the second MR damper 120 to generate compression forces by both the second MR piston 140 and the second base valve assembly 160, while rebound forces are generated substantially entirely by the second MR piston 140. This provides advantages over alternative damper designs, including better comfort and isolation, lower gas charge, wider tuning range in the compression stroke due to shorter response time and less temperature sensitivity.

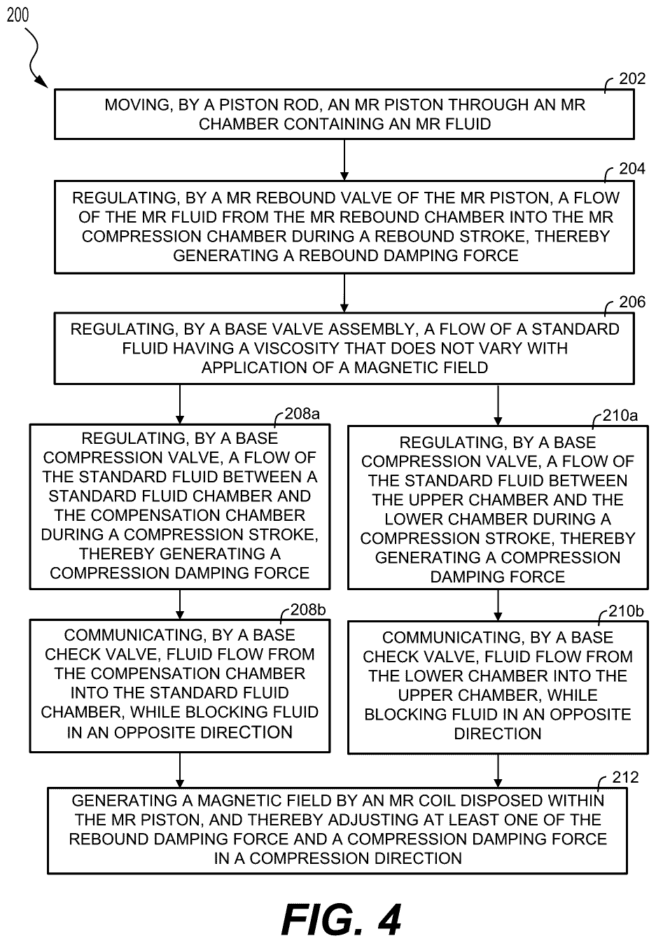

A method 200 for operating an MR damper is shown in the flow chart of FIG. 4. As can be appreciated in light of the disclosure, the order of operation within the method is not limited to the sequential execution as illustrated in FIG. 4, but may be performed in one or more varying orders as applicable and in accordance with the present disclosure.

The method 200 includes moving, by a piston rod, an MR piston through an MR chamber containing an MR fluid, at step 202.

The method 200 also includes regulating, by a MR rebound valve of the MR piston, a flow of the MR fluid from the MR rebound chamber into the MR compression chamber during a rebound stroke, thereby generating a rebound damping force, at step 204. The rebound damping force may be generated substantially entirely by the MR rebound valve of the MR piston.

The method 200 also includes regulating, by a base valve assembly, a flow of a standard fluid having a viscosity that does not vary with application of a magnetic field, at step 206.

In some embodiments, regulating the flow of the standard fluid at step 206 further includes: regulating, by a base compression valve of the base valve assembly, at step 208a, a flow of the standard fluid between a standard fluid chamber and the compensation chamber during a compression stroke, thereby generating a compression damping force; and communicating, by a base check valve, at step 208b, fluid flow from the compensation chamber into the standard fluid chamber, while blocking fluid in an opposite direction.

In some embodiments, the MR damper has a twin-tube configuration including an outer tube disposed coaxially around the main tube and defining a compensation chamber annularly between the main tube and the outer tube.

In some embodiments, the MR damper has a monotube configuration including the main tube defining a standard fluid chamber containing the standard fluid, and wherein the base valve assembly divides the standard fluid chamber into an upper chamber and a lower chamber.

In some embodiments, regulating the flow of the standard fluid at step 206 further includes: regulating, by a base compression valve of the base valve assembly, at step 210a, a flow of the standard fluid between the upper chamber and the lower chamber during a compression stroke, thereby generating a compression damping force; and communicating, by a base check valve, at step 210b, fluid flow from the lower chamber into the upper chamber, while blocking fluid in an opposite direction.

In some embodiments, the method 200 further includes generating, at step 212, a magnetic field by an MR coil disposed within the MR piston, and thereby adjusting at least one of the rebound damping force and a compression damping force in a compression direction.

In some embodiments, the MR coil is configured to adjust both of the rebound damping force and the compression damping force.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A magnetorheological (MR) damper comprising:
a main tube defining an MR chamber containing an MR fluid, the MR fluid having a viscosity that varies in response to application of a magnetic field;
a piston rod disposed at least partially within the main tube;
an MR piston connected to the piston rod and dividing the MR chamber into an MR rebound chamber and an MR compression chamber, the MR piston including an MR rebound valve configured to regulate a flow of the MR fluid from the MR rebound chamber into the MR compression chamber during a rebound stroke, thereby generating a rebound damping force;
a standard fluid chamber containing a standard fluid, the standard fluid having a viscosity that does not vary with application of a magnetic field; and
a base valve assembly configured to regulate a flow of the standard fluid, and
wherein the rebound damping force is generated substantially entirely by the MR rebound valve of the MR piston.

2. The MR damper of claim 1, wherein the MR damper has a twin-tube configuration including an outer tube disposed coaxially around the main tube and defining a compensation chamber annularly between the main tube and the outer tube.

3. The MR damper of claim 2, wherein the base valve assembly includes:
a base compression valve configured to regulate flow of the standard fluid during a compression stroke, thereby generating a compression damping force; and
a base check valve configured to allow fluid flow from the compensation chamber into the standard fluid chamber, while blocking fluid in an opposite direction.

4. The MR damper of claim 2, further comprising a fluid separator disposed within the main tube and separating the MR chamber from the standard fluid chamber for isolating the MR fluid from the standard fluid.

5. The MR damper of claim 4, wherein the fluid separator includes a floating piston which is slidable in an axial direction within the main tube.

6. The MR damper of claim 1, wherein the MR damper has a monotube configuration including the main tube defining the standard fluid chamber, and wherein the base valve assembly divides the standard fluid chamber into an upper chamber and a lower chamber.

7. The MR damper of claim 6, wherein the base valve assembly includes:
a base compression valve configured to regulate flow of the standard fluid between the upper chamber and the lower chamber during a compression stroke, thereby generating a compression damping force; and
a base check valve configured to allow fluid flow from the lower chamber into the upper chamber, while blocking fluid in an opposite direction.

8. The MR damper of claim 6, further comprising a fluid separator disposed within the main tube and separating the MR chamber from the standard fluid chamber for isolating the MR fluid from the standard fluid.

9. The MR damper of claim 8, wherein the fluid separator includes a floating piston which is slidable in an axial direction within the main tube.

10. The MR damper of claim 5, further comprising a gas cup disposed in the main tube and separating the standard fluid chamber from a gas compartment containing a gas, wherein the gas cup is slidable in an axial direction within the main tube.

11. The MR damper of claim 1, wherein the MR piston has an asymmetrical force profile, generating less force in a compression direction than the rebound damping force in a rebound direction.

12. The MR damper of claim 1, further comprising an MR coil disposed within the MR piston and configured to generate a magnetic field, and to thereby adjust at least one of the rebound damping force and a compression damping force in a compression direction.

13. The MR damper of claim 12, wherein the MR coil is configured to adjust both of the rebound damping force and the compression damping force.

14. A method for operating a magnetorheological (MR) damper, comprising:
moving, by a piston rod, an MR piston through an MR chamber containing an MR fluid, the MR fluid having a viscosity that varies in response to application of a magnetic field, the MR piston dividing the MR chamber into an MR rebound chamber and an MR compression chamber;
regulating, by a MR rebound valve of the MR piston, a flow of the MR fluid from the MR rebound chamber into the MR compression chamber during a rebound stroke, thereby generating a rebound damping force; and
regulating, by a base valve assembly, a flow of a standard fluid having a viscosity that does not vary with application of a magnetic field, and
wherein the rebound damping force is generated substantially entirely by the MR rebound valve of the MR piston.

15. The method of claim 14, wherein the MR damper has a twin-tube configuration including an outer tube disposed coaxially around the main tube and defining a compensation chamber annularly between the main tube and the outer tube.

16. The method of claim 15, wherein the regulating the flow of the standard fluid further includes:
regulating, by a base compression valve of the base valve assembly, a flow of the standard fluid between a standard fluid chamber and the compensation chamber during a compression stroke, thereby generating a compression damping force; and
communicating, by a base check valve, fluid flow from the compensation chamber into the standard fluid chamber, while blocking fluid in an opposite direction.

17. The method of claim 14, wherein the MR damper has a monotube configuration including the main tube defining a standard fluid chamber containing the standard fluid, and wherein the base valve assembly divides the standard fluid chamber into an upper chamber and a lower chamber.

18. The method of claim 17, wherein the regulating the flow of the standard fluid further includes:
regulating, by a base compression valve, a flow of the standard fluid between the upper chamber and the lower chamber during a compression stroke, thereby generating a compression damping force; and
communicating, by a base check valve, fluid flow from the lower chamber into the upper chamber, while blocking fluid in an opposite direction.

19. The method of claim 14, further comprising generating a magnetic field by an MR coil disposed within the MR piston, and thereby adjusting at least one of the rebound damping force and a compression damping force in a compression direction.

20. The method of claim 19, wherein the MR coil is configured to adjust both of the rebound damping force and the compression damping force.
